(19) United States
(12) Patent Application Publication
(10) Pub. No.: US 2006/0120310 A1
(43) Pub. Date: Jun. 8, 2006

(54) Method for improving wireless network performance in a multi-cell communication network

(75) Inventors: Juan Carlos Zuniga, Montreal (CA); Vincent Roy, Montreal (CA)

Correspondence Address: VOLPE AND KOENIG, P.C.;DEPT. ICC, UNITED PLAZA, SUITE 1600, 30 SOUTH 17TH STREET, PHILADELPHIA, PA, 19103, US

(73) Assignee: InterDigital Technology Corporation, Wilmington, DE (US)

(21) Appl. No.: 11/004,255

(22) Filed: Dec. 3, 2004

(51) Int. Cl. H04B 7/00

(52) U.S. Cl. 370/310

(57) ABSTRACT

A Radio Resource Management (RRM) module is provided to capture network topology information associated with a wireless communication network. This information is transmitted to a Smart Antenna (SA) module collocated within a network node. The SA module determines the appropriate direction, width and power of beams transmitted in the network. The SA module adjusts the direction, width, and/or power of the beams accordingly. A multi-purpose network node for communicating in a wireless communication network operates in a base station mode. If the node detects a change in the network, it determines whether the change should trigger a change in operating modes. If such a change is desired, the node switches between base station and wireless transmit/receive unit (WTRU) modes. The node continues to operate in a WTRU mode until another mode triggering event occurs. In an alternate embodiment, the multi-purpose node operates in base station and WTRU modes simultaneously.

### FIELD OF INVENTION

The present invention relates to a wireless communication network. More particularly, the present invention is a method and apparatus for reducing interference and improving overall network performance of a wireless communication network.

### BACKGROUND

As the number of wireless communication networks continues to proliferate, signal interference is fast becoming the largest roadblock to maintaining robust system performance. Signal interference occurs when network nodes are bombarded with signals from a variety of different sources, both intended and unwanted sources. It is the dual presence of intended and unwanted signals that leads to signal interference. As the presence of unwanted signals increases, the ability of network nodes to prevent interference from affecting reception of desired signals decreases.

Although current technologies exist to reduce signal interference in aggressive situations, none has been fully able to anticipate present-day deployments and resulting interference issues. In hot spot deployments, for example, factors internal to networks such as node concentration, restricted geographical regions, reduced cell sizes, and increased number of users all contribute to signal interference.

As a starting point and purely by way of example, FIG. 1 shows a simple network 100 deployment ideally situated to minimize interference. Network nodes 102 and 104 are logically linked to nodes 108 and 110 respectively, in a Point-to-Point (PtP) configuration. Network nodes 102, 104, 108, and 110 in this Figure can represent access points, base stations, mobile stations or any combination thereof. The transmission range, or coverage area, of each network 100 node is identified by circles 120 through 126. As FIG. 1 illustrates, each network 100 node's coverage area encompasses only its desired peer. As a result, each network 100 node only receives signals from, and transmits signals to, its desired peer with little or no signal interference. Although ideal, network 100 is not a realistic deployment of a wireless communication network.

FIG. 2 depicts a network 200 similar to network 100 shown in FIG. 1, except that network 200 embodies more network nodes. As illustrated in FIG. 2, nodes 202 and 204 are deployed similarly to the node pairs shown in FIG. 1. That is, node pair 202 and 204 is in a PtP configuration wherein each node's coverage area encompasses only its desired PtP peer. Specifically, node 202 only receives signals from its peer node 204, and node 204 only receives signals from its peer node 202. By contrast, node 210 is situated such that it not only receives signals from its peer node 212, but also from node 214. Similarly, node 214 is situated such that it receives desired signals from its PtP peer node 216 and unwanted signals from node 210. As a result, both nodes 210 and 214 experience signal interference.

In more complex deployments, the interference dilemma is even more pronounced. FIG. 3 depicts a network 300 deployment comprising a set of PtP links and a set of Point-to-MultiPoint (PtMP) links. In this Figure, nodes 308 and 310 are in a simple PtP configuration wherein each node receives and transmits only with its desired PtP peer. Node 302, however, is operating in a PtMP configuration with nodes 304 and 306 wherein node 302 services nodes 304 and 306. As illustrated in FIG. 3, there is extensive overlap between the coverage areas, (i.e., circles shown emanating from antenna elements in each node), of nodes 302, 304, and 306. As a result, all three nodes are susceptible to significant signal interference.

As illustrated in FIGS. 2 and 3, the more congested and/or complex networks become, the more susceptible they will be to interference. Although there are technologies that are useful in reducing network interference, these technologies are not always effective. FIG. 4, for example, illustrates a network 400 deployment employing Smart Antenna (SA) modules collocated with each node utilizing beam steering technology for reducing interference within the network 400. Smart antenna modules combined with beam steering technology are used to tailor coverage areas of network nodes. In network 400, this technology combination effectively tailors the coverage areas of nodes 406 and 408 to include only their desired PtP peers, thus minimizing signal interference. Node 410, however, remains within the coverage areas 421,423, 424 of nodes 412, 416 and 414, respectively, even with the implementation of SA modules beam steering technology. As such, node 410 receives signals from its desired peer, node 412, and from nodes 414 and 416. Similarly, node 414 remains within coverage areas 421 and 423 and thus receives signals from it peer 416 and from node 412. Reception of unwanted signals by nodes 410 and 414 results in their experiencing significant levels of inter-cellular interference.

Accordingly, it is desirable to have a method and apparatus for effectively minimizing interference in a wireless network, particularly in a network with a highly congested and/or complex topology.

### SUMMARY

The present invention is a method and apparatus for reducing interference and improving the overall performance of a wireless communication network. A Radio Resource Management (RRM) module is provided to capture network topology information associated with the wireless communication network. This topology information is transmitted to a Smart Antenna (SA) module collocated within a network node. The SA module determines the appropriate direction, width and power of beams transmitted in the wireless network. The SA module then adjusts the direction, width, and/or power of the beams accordingly.

A multi-purpose network node for communicating in a wireless communication network has a means for operating in a base station mode. If the node detects a change in the network, it has a means for determining whether the change should trigger a change in operating modes. If a change in operating modes is desired, the node has a means for switching between base station and wireless transmit/receive unit (WTRU) modes. The node continues to operate in a WTRU mode until another mode triggering change occurs. In an alternate embodiment, the multi-purpose node has a means for operating in base station and WTRU modes simultaneously.

### BRIEF DESCRIPTION OF THE DRAWINGS

A more detailed understanding of the invention may be had from the following description, given by way of example and to be understood in conjunction with the accompanying drawings wherein:

FIG. 1 is a simple point-to-point wireless network deployment ideally situated to minimize inter-cellular interference.

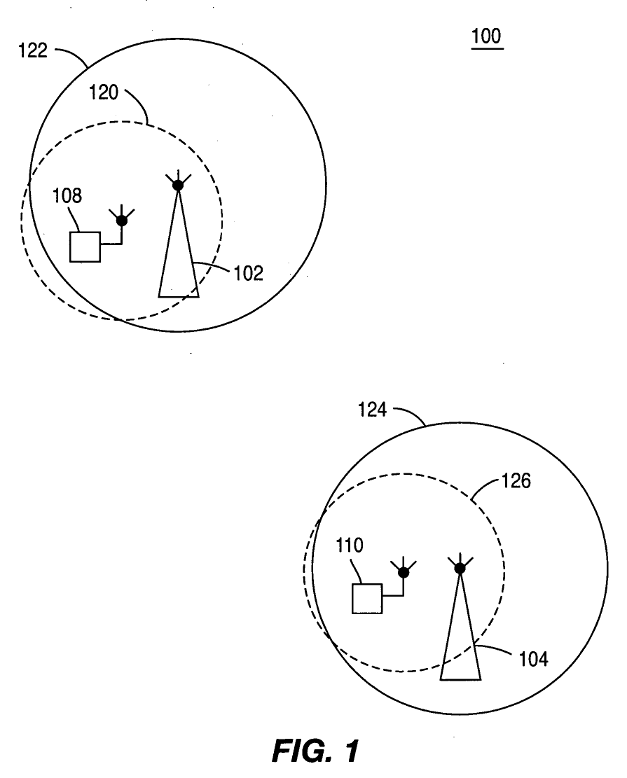

FIG. 2 is a congested point-to-point wireless network depicting the effect of unwanted signal detection.

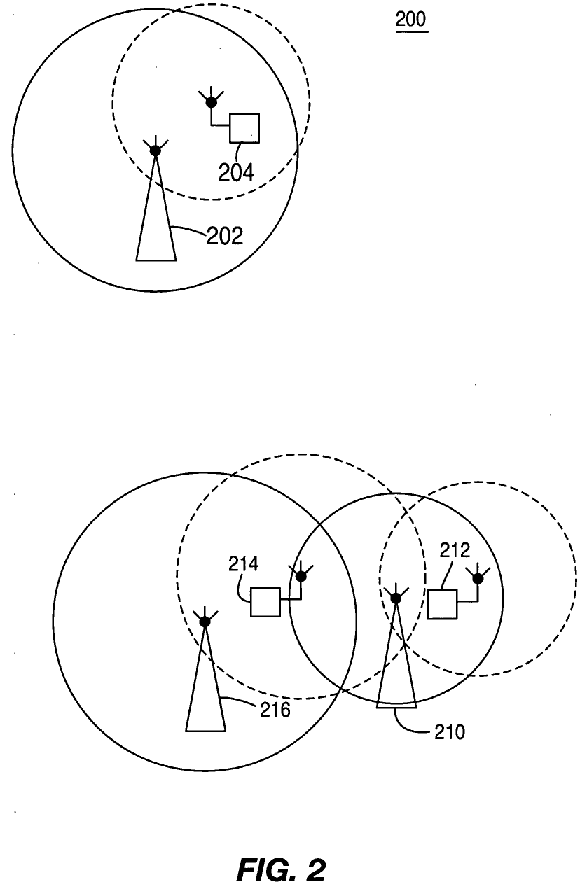

FIG. 3 is a wireless network comprising a point-to-point and a point-to-multipoint set of logical links depicting the network's susceptibility to signal interference.

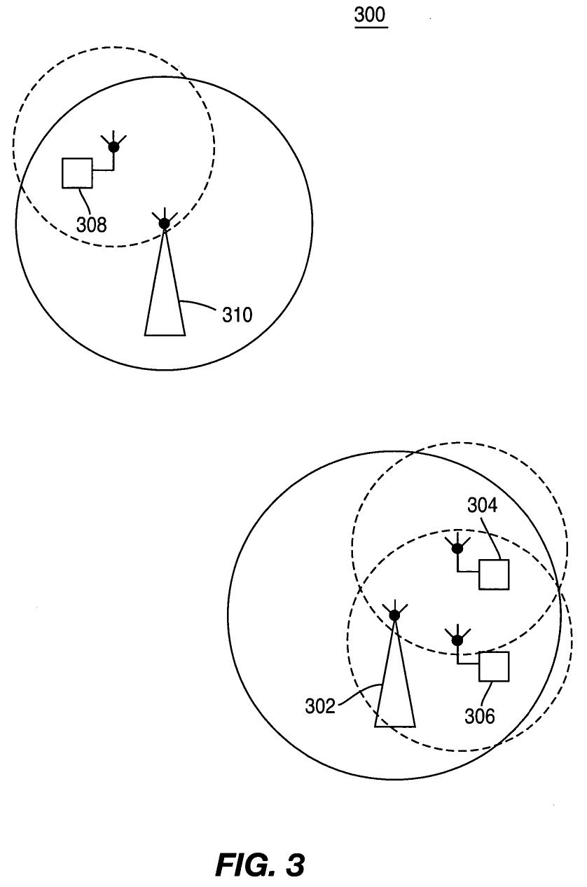

FIG. 4 is a wireless network which utilizes Smart Antenna (SA) modules and beam steering technology to minimize signal interference.

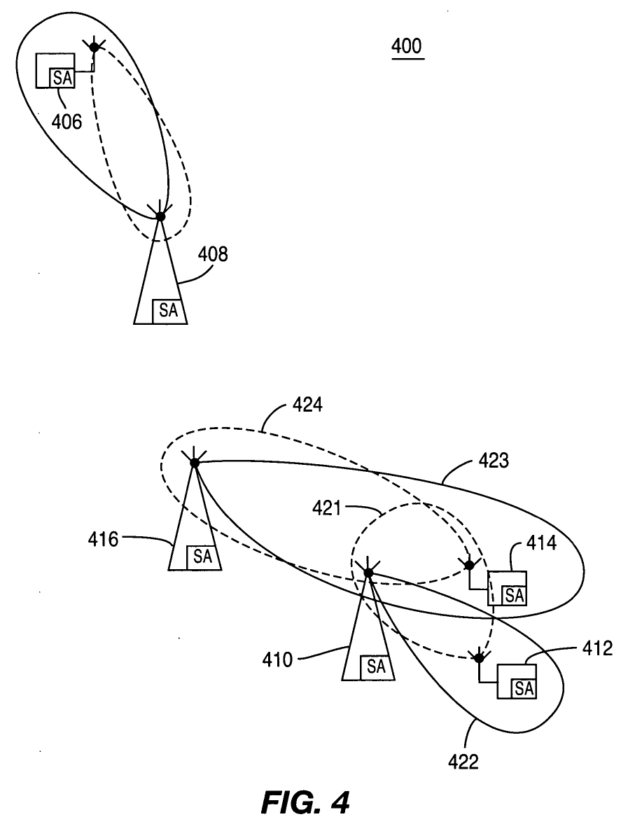

FIG. 5 is a wireless network in accordance with a preferred embodiment of the present invention.

FIG. 6 is a flow diagram of a method of minimizing inter-cellular interference in accordance with the present invention.

FIGS. 7A and 7B are a multi-purpose network node operating as a base station at a first point in time (FIG. 7A) and operating as a wireless transmit/receive unit (WTRU) at a second point in time (FIG. 7B).

FIG. 8 is a flow diagram of the method by which a multi-purpose network node switches from base station mode to WTRU mode and vice versa.

FIG. 9 is a multi-purpose network node operating as a base station and a WTRU simultaneously.

### DETAILED DESCRIPTION OF THE PREFERRED EMBODIMENTS

Hereafter, the terminology “wireless transmit/receive unit” (WTRU) includes but is not limited to a user equipment, mobile station, fixed or mobile subscriber unit, pager, or any other type of device capable of operating in a wireless environment. When referred to hereafter, the terminology “base station” includes but is not limited to a node-B, site controller, access point or any other type of interfacing device in a wireless environment.

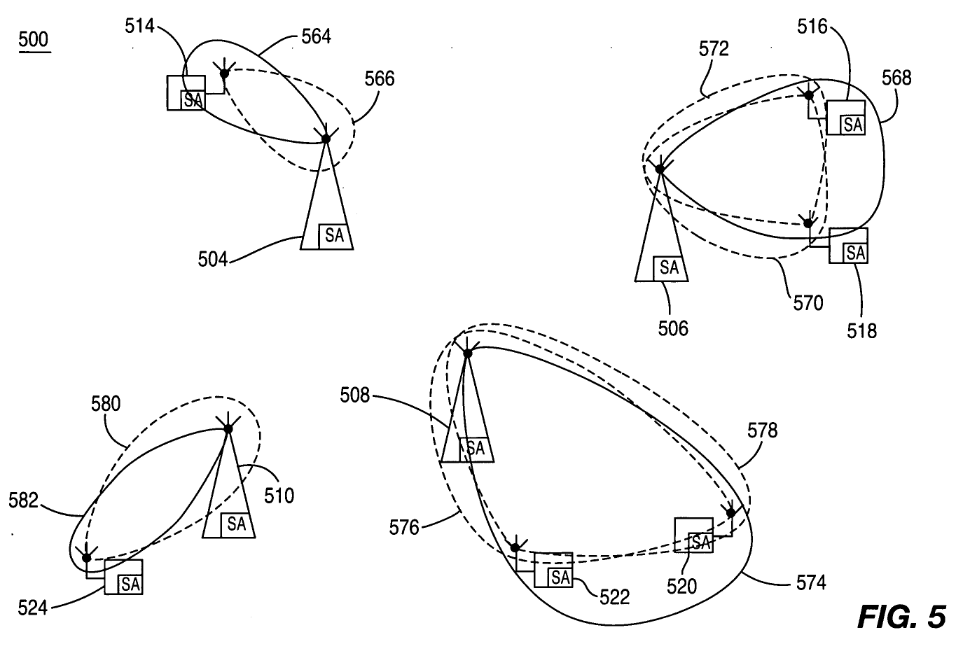

Referring now to FIG. 5, there is shown a wireless communication network 500 wherein the coverage area, (or footprint), of each network node is optimized in order to minimize signal interference. It should be understood that the deployment and network components depicted in FIG. 5 are shown purely by way of example. Both the deployment and network components may vary according to the particular type of wireless network in which the present invention is being implemented.

Network 500 includes base stations 504, 506, 508, and 510 and WTRUs 514, 516, 518, 520, 522 and 524. Base stations 504 and 510 are operating in point-to-point mode with WTRUs 514 and 524, respectively. Base stations 506 and 508, and WTRUs 516, 518, 520 and 522, are operating in point-to-multipoint mode, wherein base station 506 services WTRUs 516 and 518 and base station 508 services WTRUs 520 and 522. A;Smart Antenna (SA) module is collocated with each of the network 500 nodes. It should be understood that each of these SA modules comprises both smart antenna processing capabilities and antenna elements. The coverage areas of the base stations and WTRUs of network 500 are shown as ellipses 564-582 emanating from antenna elements embedded in each of these network 500 nodes.

Not shown in FIG. 5, however, are radio resource management (RRM) modules, one each of which is preferably collocated with each base station. These RRM modules are able to “discover” topology information of network 500 without the use of a central radio network controller (RNC). Means by which topology information is so discovered are well known in the art and are outside the scope of this invention. It should be understood, however, that the present invention is also intended to accommodate those networks in which central RNCs are utilized.

The RRM modules collocated with base stations 504, 506, 508 and 510 capture and then process the network 500 topology information in terms of the nodes they detect in their surrounding environment. Whether the topology information is discovered independently or provided from a central RNC, the topology information includes, but is not limited to, the quantity of nodes, their identity (e.g. MAC address, IP address, etc.), geographical coordinates, angles of arrival, and the logical relation among the network 500 components. For example, the topology information obtained or detected by WTRU 520 could determine that another node, namely WTRU 522, is located close to WTRU 520 at roughly 60 degrees from the azimuth between WTRU 520 and its serving base station, (namely 508). The topology information obtained or detected by WTRU 520 could also indicate that base station 510 is located further away, (i.e., an estimate of the amount of pathloss could also be performed), in the direction of the azimuth between WTRU 520 and its serving base station 508.

It should be understood that although a static network provides the ideal venue for capturing topology information, the present invention is not limited to static networks. Applying the present invention to a network comprising mobile WTRUs merely necessitates increasing the frequency at which topology information is updated such that the topology information remains relevant. In either event, once topology information is obtained or detected, the RRM modules export this information to the SA modules within their respective coverage areas, where the information is received and again processed.

The SA modules use this topology information to determine appropriate radiation patterns and transmission power levels. For example, if an RRM module identifies that a base station is communicating with a single WTRU, (e.g., PtP mode), the base station SA module narrows its beam width, reduces its transmission power, and/or adjusts its beam direction such that the single WTRU is isolated. This beam adjusting mitigates any interference generated amongst other Basic Service Sets (BSSs). A myriad of methods for beam steering and power control can be found in the prior art and are not considered to be part of this invention.

Referring back to FIG. 5, the interference reduction concept of the present invention is further illustrated. After receiving the network 500 topology information, the SA modules at base stations 506 and 508 determine that it is beneficial for the respective base stations to operate in PtMP mode, wherein base station 506 services WTRUs 516 and 518, and base station 508 services WTRUs 520 and 522. Similarly, the SA modules at base stations 504 and 510 determine that they do not need to operate in PtMP mode. Instead, their efficiency is optimized by operating in PtP mode.

It should be noted that by operating in PtMP mode, base stations 506 and 508 avoid excess data packet collisions, (i.e. interference), in network 500. If base station 506, for example, were operating in a PtP mode, the directivity of the radio links between itself and WTRUs 516 and 518 would prevent each of these WTRUs from detecting when base station 506 was communicating with the other WTRU. In essence, WTRUs 516 and 518 would be hidden from one another. When two WTRUs sharing the same radio resources are hidden from one another, they sometimes transmit at the same time, resulting in data packet collisions which result in interference. Those skilled in the art refer to this concept as the “hidden node” phenomenon.

The hidden node phenomenon is avoided in network 500 because WTRUs 516, 518, 520 and 522 are signaled to enlarge their beam widths such that their respective coverage areas encompass each of their respective PtMP peers. By enlarging their respective beam widths, each WTRU, (i.e., 516, 518, 520, 522), detects when its PtMP peer WTRU is transmitting on their shared channel. Accordingly, each of these WTRUs delays transmitting signals until it detects that its PtMP peer WTRU is no longer transmitting. To illustrate, WTRUs 516 and 518 have enlarged beam widths such that their respective coverage areas encompass each other along with base station 506. If WTRU 516 detects that WTRU 518 is transmitting on their shared channel to base station 506, WTRU 516 delays transmitting to base station 506 until it detects that WTRU 518 is no longer transmitting. If by chance WTRUs 516 and 518 begin transmitting at the exact same time and a collision results, a random back-off procedure is initiated, whereby each of the WTRUs 516, 518 stops transmitting and waits for a random period of time before attempting a retransmission. This significantly reduces the chances of subsequent collisions.

It should be noted that base stations 506 and 508 could alternatively signal their respective WTRUs to transmit in omni-directional mode, which would have the same effect as beam enlarging discussed above. Preventing multiple WTRUs from simultaneously transmitting to the same base station on a shared channel results in fewer collisions on that shared channel. Consequently, the shared channel becomes more efficient and the performance of the overall network improves.

In addition, reception patterns of all smart antennas collocated within base stations 504, 506 and 508 and WTRUs 514, 516, 518, 520 and 522 can be adjusted to further optimize reception of signals and minimize interference in network 500.

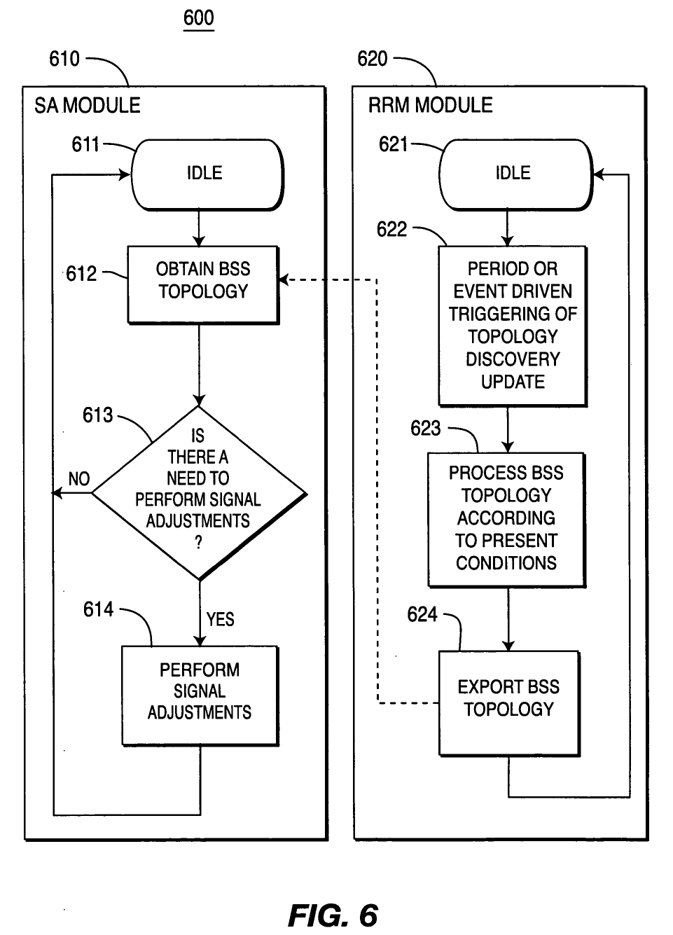

The method 600 for minimizing inter-cellular interference in network 500 of FIG. 5 is set forth in the flow diagram of FIG. 6. Method 600 is performed by an SA module 610 and a RRM module 620. RRM module 620 is idle (step 621) until a topology discovery update is triggered (step 622). During this discovery step 622, network nodes are identified as base stations or WTRUs, node proximity and relative angles between the nodes are calculated, pathloss separation between pairs of nodes is identified, and the ability of nodes to sense other nodes is captured. The triggering may be periodic, or may be in response to the arrival or departure of a user into or out of a wireless communication network, (i.e., a change in network topology).

The BSS topology is processed (step 623), (i.e., the output from the discovery step 622 is transformed to be comprehensible and transportable), according to the present network conditions. The processed topology is then exported to an appropriate SA module 610 during step 624. It should be noted that although one SA module 610 is shown, there may be several or many SA modules communicating with a single RRM module 620.

Upon receiving the BBS topology information in step 612, the SA module 610 determines whether to steer the direction, change the beam width, or correct the power level of signals being transmitted by the affected network nodes (step 613). If beam steering, beam width change or power correction is not necessary, SA module 610 returns to step 611, where it is idle. If beam steering, beam width change or power correction is necessary, the SA module makes these adjustments (step 614) and then returns to step 611 (where it is idle) until it receives the next topology update from RRM module 620 (step 612).

Referring back to FIG. 5, network 500 comprises a series of network nodes, each functioning as either a base station or as a WTRU. There are cases in which it is preferable that particular nodes operate as base stations, such as nodes 506 and 508; and other particular nodes operate as WTRUs, such as nodes 516, 518, 520 and 522. There are, however, additional situations where it is desirable for certain nodes to function as base stations at one point in time and as WTRUs at a later point in time. In these situations, a multi-purpose device in accordance with the present invention can be utilized. This multi-purpose device includes all of the functionality of a base station; with the added functionality of a WTRU. The multi-purpose device also includes a mechanism by which it selectively switches back and forth between a base station mode and a WTRU mode. With this multi-purpose device, the RRM of the present invention determines in which mode the node should operate at any given point in time. This multi-purpose node then switches to the appropriate mode to accommodate the current BSS topology.

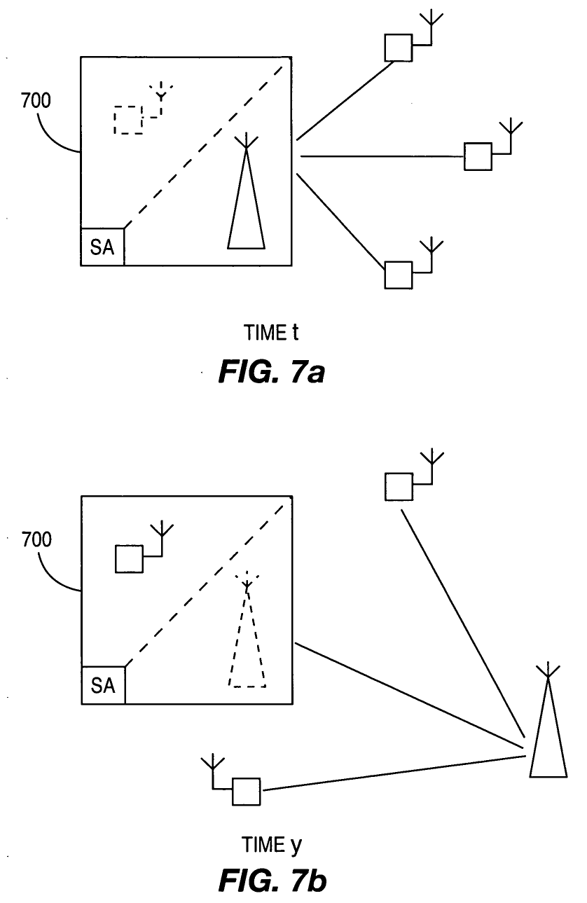

Referring to FIGS. 7A and 7B, a multi-purpose network node 700 is shown. In FIG. 7A, the multi-purpose network node 700 is operating as a base station at time t; while FIG. 7B shows the same node operating as a WTRU at a later time y. The triggering event for switching from base station mode to WTRU mode or from WTRU mode to base station mode is considered to be an external input to the process. Examples of such external inputs include: 1) a change in parameter settings from an Operation and Management (O&M) module; or 2) detecting the presence of additional network nodes. Detecting the presence of a given base station, for example, could trigger a switch from base station mode to WTRU mode. Similarly, detecting the presence of a certain set of WTRU(s) could trigger a switch from WTRU mode to base station mode.

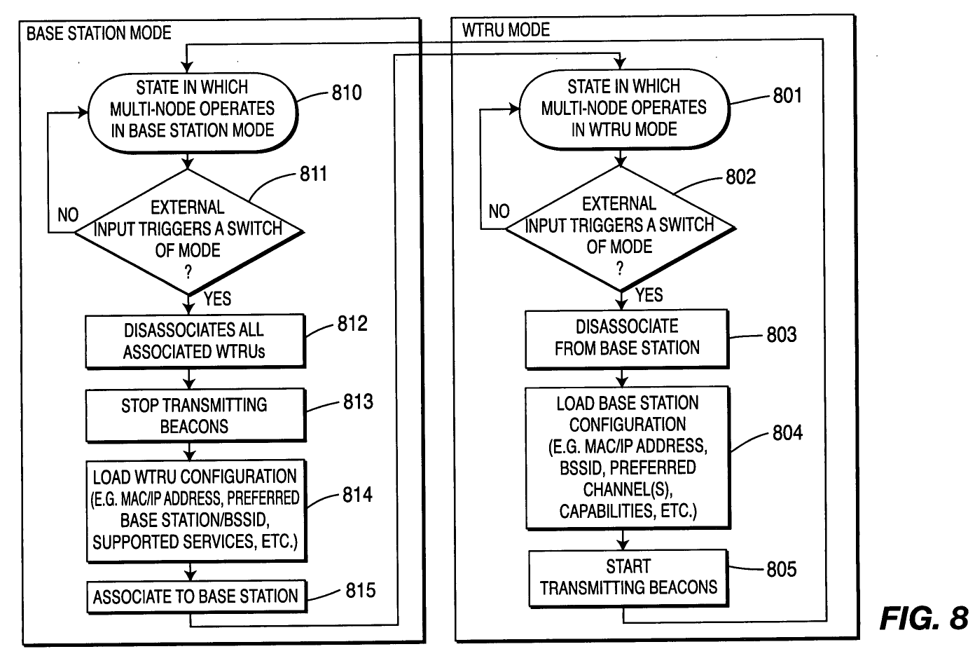

The process 800 by which the multi-purpose device 700 switches from a base station mode to a WTRU mode and from a WTRU mode to a base station mode is shown in FIG. 8. Assume for the purposes of this illustration that multi-purpose node 700 described above is operating in a wireless communication network as a base station (step 810) at a time t. At some later point in time, but before time y, node 700 detects the presence of another base station in the network. Node 700, by way of its RRM module, determines whether this network change, described above as an external input to this process, is the type to trigger a switch in its operation from a base station mode to a WTRU mode (step 811). If this were not such a change, node 700 would continue to operate in a base station mode. Since, however, the presence of an additional base station is a mode changing event, node 700 disassociates with all WTRUs with which it is currently associated (step 812). Next, node 700 ceases transmitting beacons (step 813) and begins loading its own WTRU configuration (e.g., MAC/IP address, preferred base station/BSS ID, supported services, etc.) (step 814). To complete its transformation, node 700 associates with a base station (step 815) and begins operating in a WTRU mode (step 801) at a time y.

Suppose that at a later time z node 700 is still operating in a WTRU mode (step 801) when it experiences a change in parameter settings from an Operation and Management (O&M) module in the network. Node 700, by way of its RRM module, determines that such a change in parameter settings is a mode switching event (step 802). As a result, node 700 disassociates from the base station to which it is currently associated (step 803). Next, node 700 loads its own base station configuration information (e.g. MAC/IP address, BSS ID, preferred channel(s), capabilities, etc.) (step 804). Once reconfigured, node 700 transmits beacons (step 805) and begins to operate in a base station mode once (step 810). Node 700 continues to operate in a base station mode until it determines that another mode switching event has occurred in the network.

In a scenario in which a multi-purpose device is required to function as both a base station and a WTRU simultaneously, multiple radio units and multiple antenna structures may be utilized to transmit and receive signals on different channels, thereby allowing for the isolation between radio signals of the WTRU and base station portions of such a device.

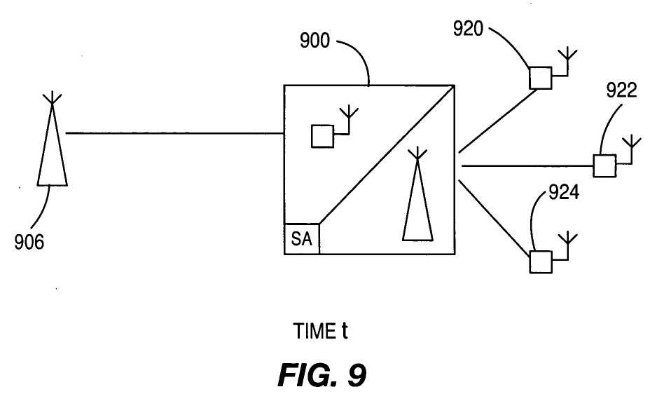

FIG. 9 is a multi-purpose node 900 in accordance with the present invention, whereby the node 900 functions as both a base station and WTRU simultaneously. To better illustrate an application of this multi-purpose node 900 and purely by way of example, suppose that node 900 in FIG. 9 is located in a commercial airplane. Further, suppose base station 906 represents an airport and WTRUs 920, 922 and 924 represent passenger entertainment units collocated with node 900 on a commercial airplane. In this example, the airplane is docked at the airport 906 and is in communication with the airport 906, receiving information such as flight schedules, passenger lists, weather conditions, and other important flight information. At the same time, multi-purpose node 900 is providing movies and music to passengers via entertainment units 920, 922 and 924. While multi-purpose 900 is both receiving information from the airport 906 and providing entertainment to passengers, it is simultaneously operating as a base station and as a WTRU. Once the airplane departs the airport 906 and is in flight, an RRM module and an SA module, (both collocated within node 900), signal multi-purpose node 900 to behave solely as a base station, so as to provide the passenger entertainment units 920, 922, 924 with an access point from which to receive information and entertainment.

What is claimed is:

1. A method for improving the performance of a wireless communication network, the method comprising:
(a) capturing network topology information associated with the wireless communication network;
(b) determining parameters of beams transmitted within the wireless communication network, said parameters including at least one of direction, width and power level; and
(c) adjusting at least one of said beam parameters.

2. The method of claim 1 wherein the wireless communication network comprises at least two network nodes wherein a Smart Antenna (SA) module is collocated with each node.

3. The method of claim 2 wherein the network topology information includes the location of each network node and the direction, width and power level of beams transmitted in the network.

4. The method of claim 3 wherein said determination of step (b) is based on said network topology information.

5. The method of claim 4 further comprising:
(a1) providing a Radio Resource Management (RRM) module to capture the network topology information;
(a2) transmitting the topology information to a Smart Antenna (SA) module;
(b1) in the SA module, determining the parameters of beams transmitted in the wireless network; and
(c1) adjusting the beam parameters utilizing the SA module.

6. The method of claim 5 wherein the wireless communication network comprises Point-to-Point (PtP) links.

7. The method of claim 5 wherein the wireless communication network comprises Point-to-MultiPoint (PtMP) links.

8. The method of claim 5 wherein the wireless communication network comprises both PtP and PtMP links.

9. A multi-purpose network node for communicating in a wireless communication network, the node comprising:
means for operating in a base station mode;
means for operating in a WTRU mode;
means for detecting changes in the network;
means for determining whether to switch operating modes; and
means for switching, in response to said determining means, between said base station mode and said wireless transmit/receive unit (WTRU) mode.

10. The multi-purpose node of claim 9 wherein the switching means further comprises:
if the node is operating in a base station mode:
means for disassociating with all associated WTRUs;
means for ceasing transmission of beacons;
means for loading a WTRU configuration; and
means for associating to a base station; and
if the node is operating in a WTRU mode:
means for disassociating from a base station;
means for loading a base station configuration; and
means for transmitting beacons.

11. A method of switching a multi-purpose network node from a base station mode to a WTRU mode; the node communicating in a wireless communication network comprising at least one WTRU and at least one base station, the method comprising:
(a) detecting changes in the wireless communication network;
(b) determining whether to change from the base station mode to the WTRU mode;
(c) disassociating with associated WTRUs;
(d) ceasing transmission of beacons;
(e) loading a WTRU configuration; and
(f) associating to a base station.

12. A method of switching a multi-purpose network node from a WTRU mode to a base station mode; the node communicating in a wireless communications network comprising at least one WTRU and at least one base station, the method comprising:
(a) detecting changes in the wireless communication network;
(b) determining whether to change from the WTRU mode to the base station mode;
(c) disassociating from an associated base station;
(d) loading a base station configuration; and
(e) transmitting beacons.

13. A multi-purpose network node for communicating in a wireless communication network; the network comprising at least one WTRU and at least one base station, the node comprising:
means for operating in a base station mode;
means for operating in a WTRU mode;
means for detecting changes in the network; and
means for determining whether to operate in at least one of a base station mode and a WTRU mode.
